(19) United States
(12) Patent Application Publication
(10) Pub. No.: US 2025/0323452 A1
(43) Pub. Date: Oct. 16, 2025

(54) Seal For A Connector

(71) Applicant: TE Connectivity Solutions GmbH, Schaffhausen (CH)

(72) Inventors: Vishnu Patagar, Winston Salem, NC (US); William John Remaley, Winston Salem, NC (US); Daniel Stack, Winston Salem, NC (US)

(73) Assignee: TE Connectivity Solutions GmbH, Schaffhausen (CH)

(21) Appl. No.: 19/055,820

(22) Filed: Feb. 18, 2025

Related U.S. Application Data
(60) Provisional application No. 63/632,709, filed on Apr. 11, 2024.

(51) Int. Cl. H01R 13/52

(52) U.S. Cl. CPC H01R 13/5219

(57) ABSTRACT

A seal includes a body and a plurality of lugs separated from one another around a perimeter of the body and extending from the body along the longitudinal direction. The body defines a scaling passageway extending along a longitudinal direction through the seal. The body and the lugs are monolithically formed in a single piece from an elastomeric material.

### CROSS-REFERENCE TO RELATED APPLICATION

This application claims priority under 35 U.S.C. § 119 to U.S. Provisional Patent Application No. 63/632,709, filed on Apr. 11, 2024.

### FIELD OF THE INVENTION

The present invention relates to a seal and, more particularly, to a seal for a connector.

### BACKGROUND OF THE INVENTION

In a system in which a connector is mated with a mating connector, a seal is often positioned and compressed between the connector and the mating connector in a mated position. The seal, such as a typical O-ring, is positioned peripherally around one of the connectors prior to mating, for example in a groove of a housing of one of the connectors. In the mating position, the seal prevents or limits the ingress of moisture and other environmental conditions that could affect the electrical connection between the connector and the mating connector.

As the connector is repeatedly mated and unmated from the mating connector, each mating cycle imparts compressive and rotational forces on the seal. Upon unmating, these forces can dislodge the seal from the groove, separating the seal from the connector or at least moving the seal to an improper orientation on the connector. The mating and unmating forces, or other forces occurring during handling and transit, can also change the orientation of the seal by rotating the seal about the connector. The dislodging, changed orientation, or other movement of the seal with respect to the connector can result in leaks or generally unreliable sealing of the electrical connection. Although it is also possible to overmold the seal on the connector to prevent movement, this process is comparatively expensive and limits the serviceability of the seal.

### SUMMARY OF THE INVENTION

A seal includes a body and a plurality of lugs separated from one another around a perimeter of the body and extending from the body along the longitudinal direction. The body defines a sealing passageway extending along a longitudinal direction through the seal. The body and the lugs are monolithically formed in a single piece from an elastomeric material.

### BRIEF DESCRIPTION OF THE DRAWINGS

The invention will now be described by way of example with reference to the accompanying Figures, of which:

FIG. 1 is a perspective view of a connector according to an embodiment;

FIG. 2 is a perspective view of a seal of the connector;

FIG. 3 is a perspective view of a housing of the connector;

FIG. 4 is a top plan view of the housing;

FIG. 5 is a perspective view of a cap of the connector;

FIG. 6 is a sectional side view of the connector, taken along line 6-6 of FIG. 1;

FIG. 7 is another sectional side view of the connector, taken along line 7-7 of FIG. 1;

FIG. 8 is a sectional side view of a connector assembly according to an embodiment including the connector and a mating connector;

FIG. 9 is a perspective view of a seal according to another embodiment; and

FIG. 10 is a sectional side view of a connector according to another embodiment having the seal of FIG. 9, taken along the same section line as shown in FIG. 6 for the connector of FIG. 1.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art. In addition, in the following detailed description, for purposes of explanation, numerous specific details are set forth to provide a thorough understanding of the disclosed embodiments. However, it is apparent that one or more embodiments may also be implemented without these specific details.

Throughout the drawings, only one of a plurality of identical elements may be labeled in a figure for clarity of the drawings, but the detailed description of the element herein applies equally to each of the identically appearing elements in the figure. Throughout the specification, directional descriptors are used such as “longitudinal direction” and “radial direction”. These descriptors are merely for clarity of the description and for differentiation of the various directions. These directional descriptors do not imply or require any particular orientation of the disclosed elements.

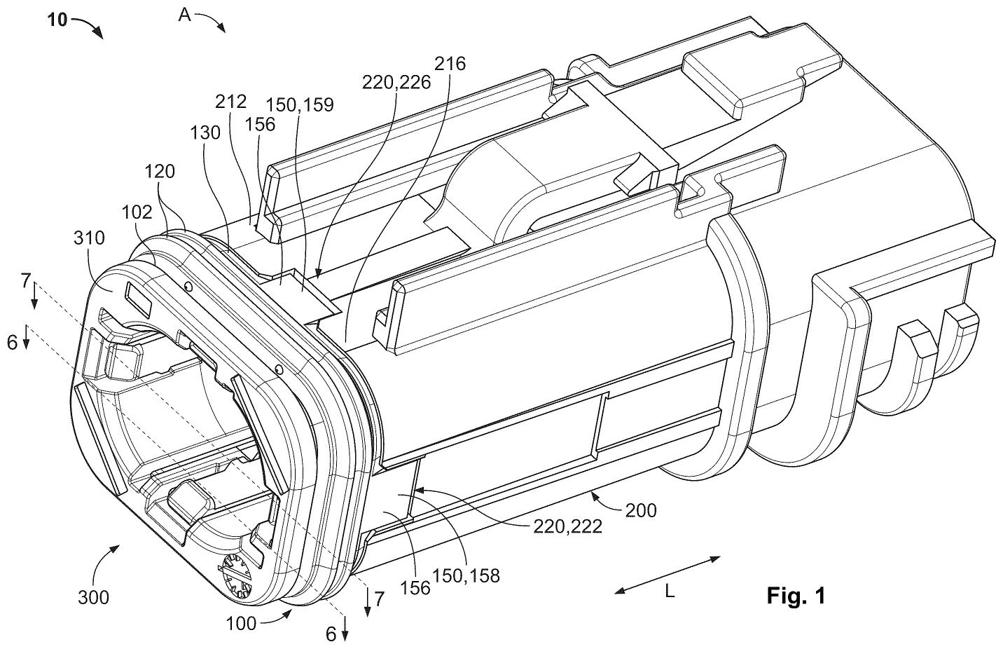

A connector 10 according to an embodiment is shown in an assembled state A in FIG. 1. The connector 10 includes a seal 100, a housing 200 on which the seal 100 is disposed, and a cap 300 securing the seal 100 on the housing 200.

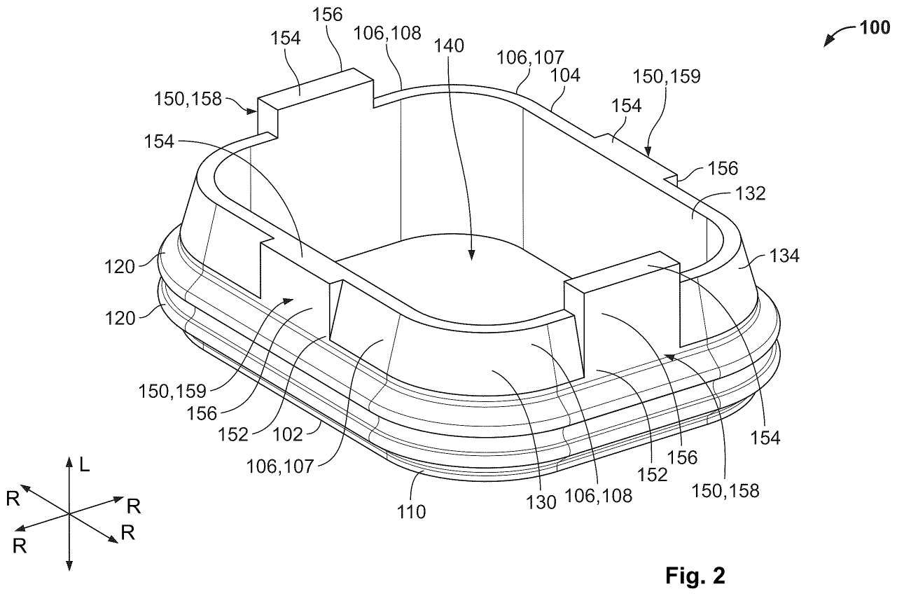

The seal 100, as shown in FIG. 2, extends from a first end 102 to a second end 104 opposite the first end 102 along the longitudinal direction L. The seal 100 has a body 110 at the first end 102 and a shroud 130 that extends from the body 110 to the second end 104. The body 110 and the shroud 130 define a sealing passageway 140 extending along the longitudinal direction L through the seal 110, as shown in FIG. 2; the body 110 and the shroud 130 each have a shape that circumferentially surrounds the sealing passageway 140.

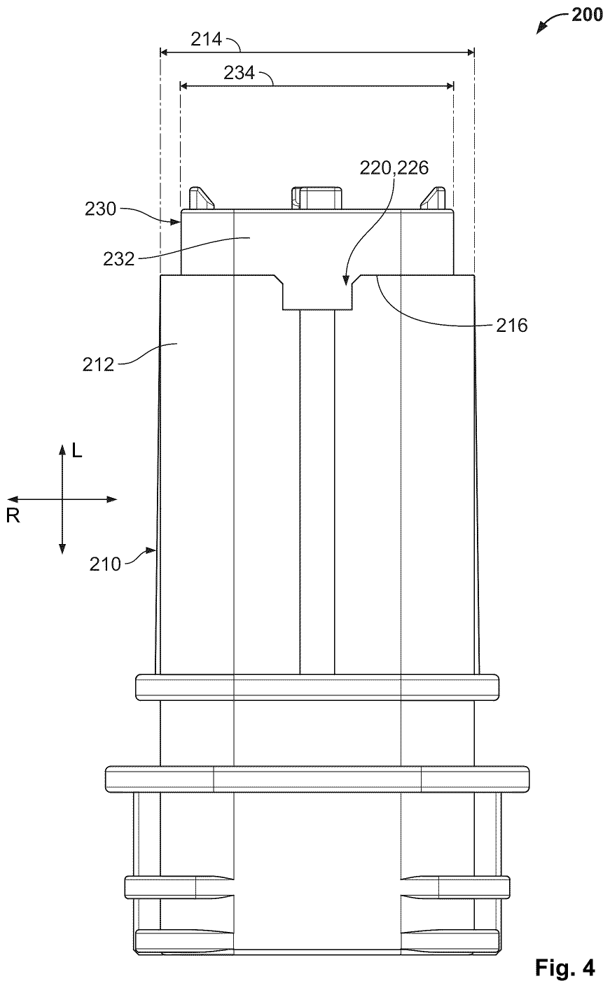

In the embodiment shown in FIG. 4, the seal 100 has four sides 106, including two long sides 107 opposite one another connected to two short sides 108 opposite one another. In other embodiments, the seal 100 may have different numbers of sides 106 with different relative lengths.

The seal 100, as shown in FIG. 2, has a plurality of sealing glands 120 extending outward from the body 110. The sealing glands 120 are ridges protruding from the body 110 that are spaced apart from one another along the longitudinal direction L. In the shown embodiment, the seal 100 has two sealing glands 120 that are both positioned on the body 110 spaced apart from the first end 102 of the body 110. In other embodiments, the seal 100 could have one sealing gland 120 or three or more sealing glands 120 positioned in different locations on the body 110 along the longitudinal direction L. In the shown embodiment, the sealing glands 120 extend continuously circumferentially around the body 110. In other embodiments, the scaling glands 120 could alternatively be discontinuous.

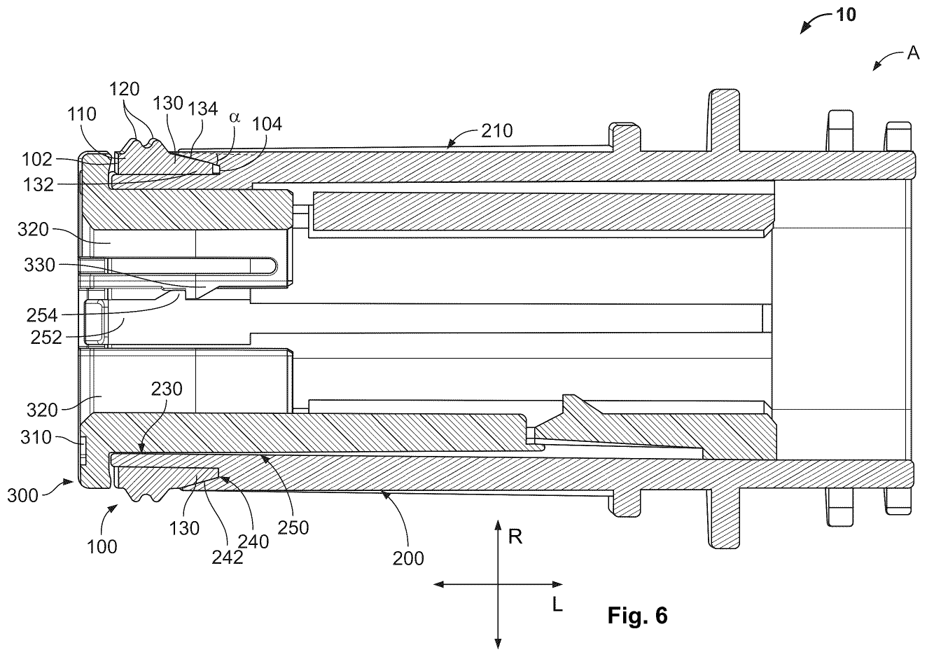

The shroud 130 tapers from the body 110 to the second end 104 of the seal 100 along the longitudinal direction L, as shown in FIGS. 2 and 6. An inner surface 132 of the shroud 130 extends along the longitudinal direction L and an outer surface 134 of the shroud 130 is sloped and extends at an angle α with respect to the longitudinal direction L. The angle α is greater than 0° and less than 90° and, in the embodiment shown in FIG. 6, is greater than 0° and less than 45°.

As shown in FIG. 2, the seal 100 has a plurality of lugs 150 extending from the body 110 and protruding from the shroud 130. The lugs 150 protrude from the outer surface 134 of the shroud 130 and each extend from a connecting end 152 at the body 110 to a protruding end 154 opposite the connecting end 152 along the longitudinal direction L. The lugs 150 are separated from one another around a perimeter of the body 110. The lugs 150 each have an outer surface 156 that extends along the longitudinal direction L; due to the slope of the shroud 130, the protruding end 154 of each of the lugs 130 protrudes further from the outer surface 134 of the shroud 130 than the connecting end 152 in a radial direction R perpendicular to the longitudinal direction L.

The lugs 150, in the embodiment shown in FIG. 2, include a first set 158 and a second set 159. The first set 158 of lugs 150 each have the protruding end 154 extending beyond the second end 104 of the seal 100 in the longitudinal direction L. The second set 159 of lugs 150 each have the protruding end 154 aligned with the second end 104 of the seal 100. In other embodiments, all of the lugs 150 may extend beyond the second end 104 of the seal 100 or all of the lugs 150 may be aligned with the second end 104 of the seal 100.

The lugs 150 are each positioned on one of the sides 106 of the seal 100. In the embodiment of the seal 100 shown in FIG. 2 in which the seal 100 has four sides 106, one of the lugs 150 is positioned on each of the four sides 106. In the embodiment of FIG. 2, the lugs 150 of the first set 158 are positioned on the opposite short sides 108 of the seal 100 and the lugs 150 of the second set 159 are positioned on the opposite long sides 107 of the seal 100; in other embodiments, the lugs 150 of the first set 158 and the second set 159 may be arranged differently.

In the shown embodiment, the seal 100, including the body 110, the sealing glands 120, the shroud 130, and the lugs 150, is monolithically formed in a single piece. The seal 100 may be formed from an elastomeric material, such as silicone. The seal 100 is formed in the single piece separate from the housing 200 and the cap 300, for example by molding.

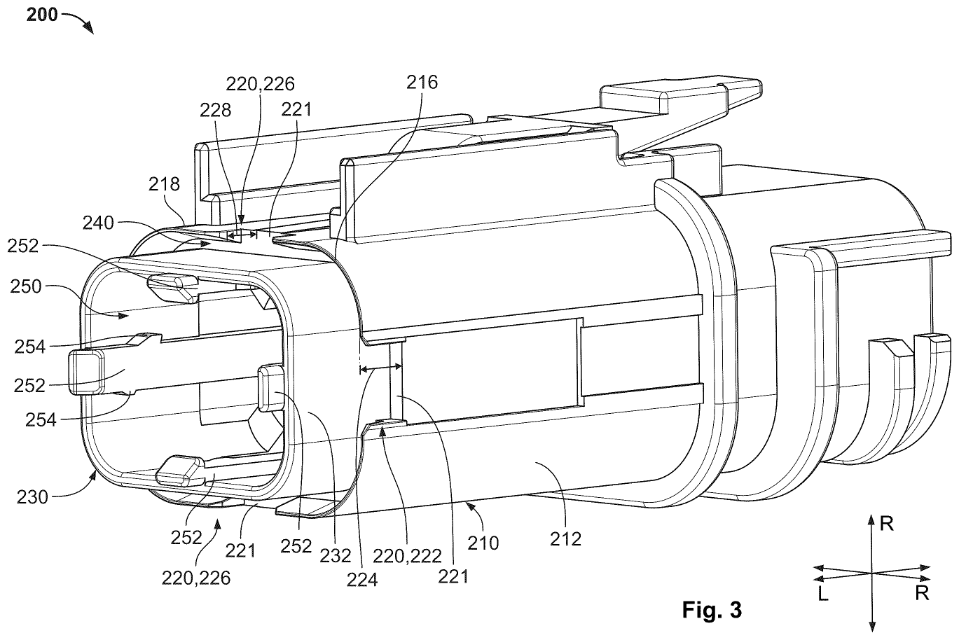

The housing 200, as shown in FIGS. 3 and 4, has a main portion 210 and a scaling portion 230 extending from the main portion 210 along the longitudinal direction L. In the shown embodiment, the housing 200 is monolithically formed in a single piece from an electrically insulative material, such as a plastic.

The main portion 210 has a first outer surface 212, as shown in FIGS. 3 and 4, and extends to a main portion end 216 along the longitudinal direction L. The first outer surface 212 has a first outer dimension 214, as shown in FIG. 4. The sealing portion 230 has a second outer surface 232 with a second outer dimension 234, as shown in FIG. 4. The second outer dimension 234 is less than the first outer dimension 214; the second outer surface 232 of the sealing portion 230 is stepped down with respect to the first outer surface 212 of the main portion 210.

As shown in FIGS. 3 and 4, the main portion 210 of the housing 200 has a plurality of locking slots 220 extending into the main portion end 216 along the longitudinal direction L and terminating in an end face 221. The locking slots 220 are spaced apart from one another along a perimeter 218 of the main portion 210. In the shown embodiment, the main portion 210 has four locking slots 220. In other embodiments, the main portion 210 could have three or less or five or more locking slots 220; the number and arrangement of the locking slots 220 corresponds to the number and arrangement of the lugs 150 on the seal 100.

The locking slots 220 include a first group 222 and a second group 226, as shown in FIG. 3. The first group 222 has a first depth 224 along the longitudinal direction L from the main portion end 216. The second group 226 has a second depth 228 along the longitudinal direction L from the main portion end 216 that is different from the first depth 224. The first depth 224 is greater than the second depth 228.

As shown in FIG. 3, the housing 200 has a seal channel 240 between the main portion 210 and the sealing portion 230. The seal channel 240 is positioned between the main portion end 216 of the main portion 210 and the second outer surface 232 of the sealing portion 230 in the radial direction R. The seal channel 240 extends circumferentially around the housing 200 and communicates with each of the locking slots 220. As shown in greater detail in FIG. 6, the seal channel 240 has a tapered shape 242 along the longitudinal direction L.

The housing 200 defines an inner receiving space 250, as shown in FIG. 3, in which a plurality of arms 252 are disposed. In the shown embodiment, catches 254 are positioned on each of the arms 252. In other embodiments, the catches 254 could be arranged in different numbers and in different positions than shown in the figures; in an embodiment, the arms 252 could be omitted and the catches 254 could be positioned on inner walls of the housing 200 defining the inner receiving space 250.

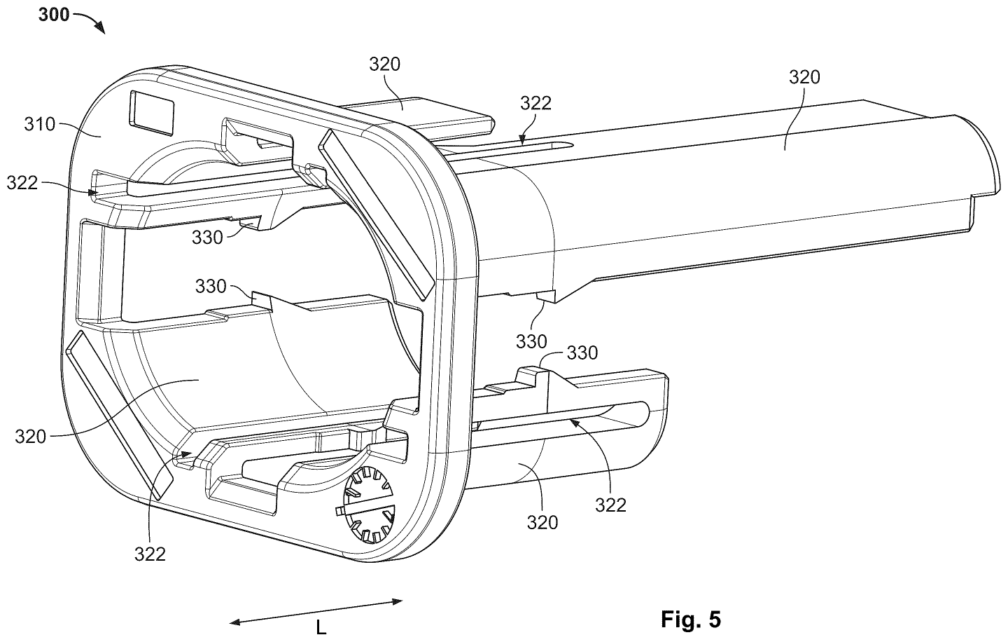

The cap 300, as shown in FIG. 5, has an end flange 310 and a plurality of legs 320 extending from the end flange 310 along the longitudinal direction L. The cap 300 has a plurality of latches 330 that are positioned on the legs 320. In the shown embodiment, the legs 320 each have a recess 322 that permits resilient deflection of a portion of the leg 320 having one of the latches 330. In the shown embodiment, the cap 300 is monolithically formed in a single piece from an electrically insulative material, such as a plastic.

An assembly of the connector 10 to the assembled state A will now be described primarily with respect to FIGS. 1, 6, and 7.

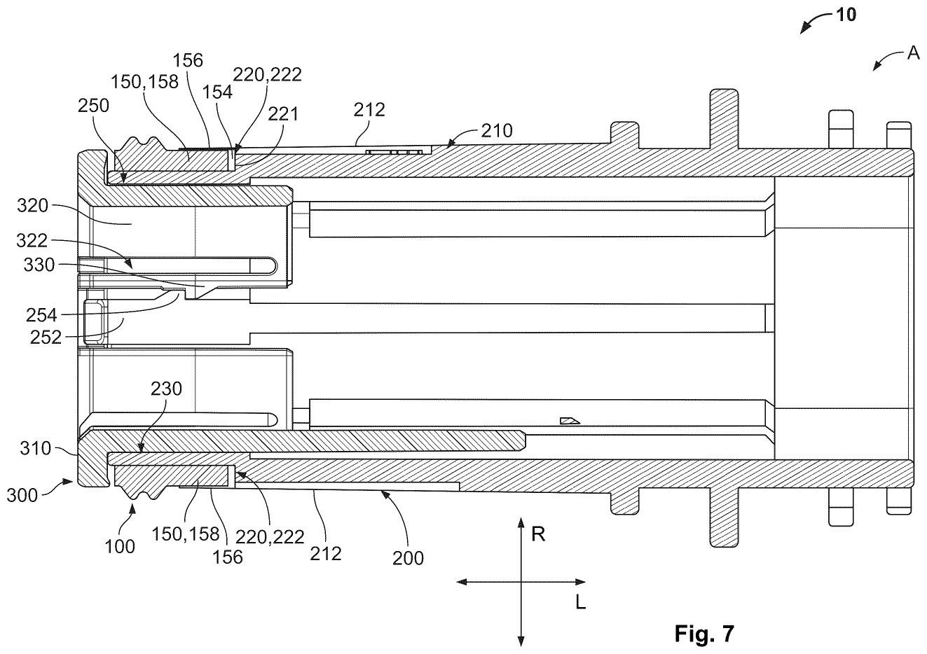

With the cap 300 separated from the housing 200, the seal 100 is disposed on the housing 200 and positioned around the sealing portion 230, as shown in FIGS. 6 and 7. The seal 100 is moved over the sealing portion 230 along the longitudinal direction L.

As shown in FIG. 6, the shroud 130 of the seal 100 is received in the seal channel 240 of the housing 200. The tapered shape of the shroud 130, sloped on the outer surface 134 at the angle α, is complementary to the tapered shape 242 of the seal channel 240. In the assembled state A of the seal 100 on the housing 200, the shroud 130 is positioned between the main portion 210 of the housing 100 and the sealing portion 230 of the housing 200 along the radial direction R.

In the assembled state A, as shown in FIGS. 1 and 7, each of the lugs 150 is received in one of the locking slots 220. The lugs 150 are positioned on the seal 100 in correspondence with the locking slots 220 on the housing 200; the lugs 150 of the first set 158 having the extended protruding end 154 are each received in one of the first group 222 of locking slots 220 having the greater first depth 224, and the lugs 150 of the second set 159 having the protruding end 154 aligned with the second end 104 of the seal 100 are each received in one of the second group 226 of locking slots 220 having the lesser second depth 228. The protruding end 154 of each of the lugs 150 is positioned adjacent to the end face 221 of one of the locking slots 220.

The lugs 150 have a low profile in the assembled state of the seal 100 on the housing 200. As shown in FIGS. 1 and 7, the outer surface 156 of each of the lugs 150 is positioned within the first outer surface 212 or can be flush with the first outer surface 212 of the main portion 210.

In the embodiments shown in FIGS. 1, 6, and 7, with the seal 100 positioned around the sealing portion 230 of the housing 200, the cap 300 is attached to the housing 200 to secure the seal 100 in the assembled position A. The cap 300 is inserted into the inner receiving space 150 along the longitudinal direction L. The legs 320 move along the arms 252 and, during insertion, the latches 330 resiliently deflect and return to engage with the catches 254 in the position shown in FIGS. 6 and 7, releasably securing the cap 300 to the housing 200. The end flange 310 of the cap 300 retains the seal 100 in position on the sealing portion 230 in this embodiment.

In another embodiment, the cap 300 can be omitted. In this embodiment, the seal 100 is positioned in a channel of the housing 200 that forms the sealing portion 230, but otherwise has the same positioning of the shroud 130 in the seal channel 240 and the lugs 150 in the locking slots 220 as described above.

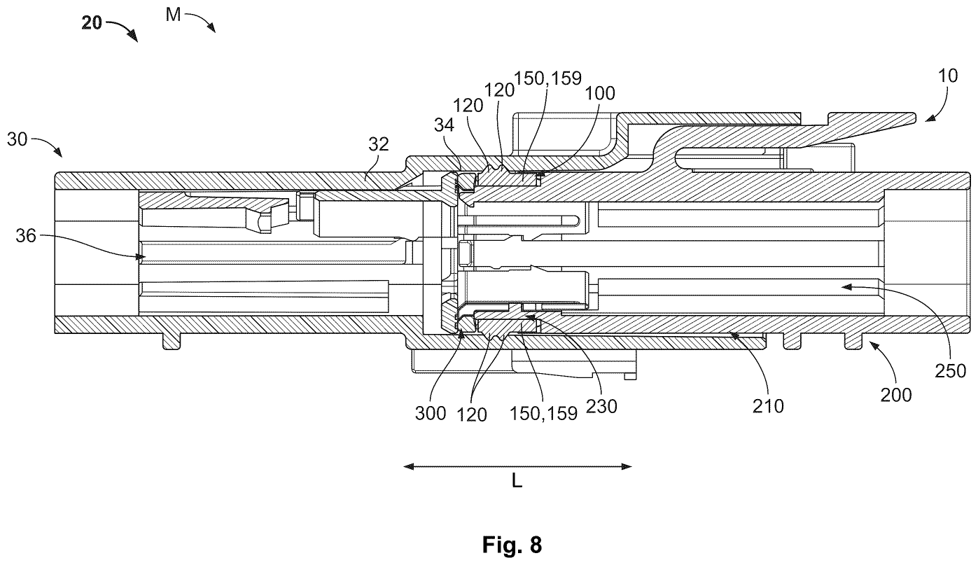

The connector 10 is matable with a mating connector 30 along the longitudinal direction L to form a connector assembly 20, as shown in FIG. 8. The mating connector 30 has a mating connector housing 32 that has an inner surface 34 defining a mating receiving space 36. During mating, the connector 10 is inserted into the mating receiving space 36 and the inner surface 34 of the mating connector housing 32 engages the seal 100, compressing the sealing glands 120, to form a seal between the connector 10 and the mating connector 30 in a mated state M of the connector assembly 20. The seal 100 is compressed between the housing 200 of the connector 10 and the mating connector housing 32 of the mating connector 30. In the mated state M, contacts of the connector 10 disposed in the inner receiving space 250 of the housing 200 are mated with mating contacts of the mating connector 30 disposed in the mating receiving space 36 of the mating connector housing 32 to form an electrical connection between the connector 10 and the mating connector 30.

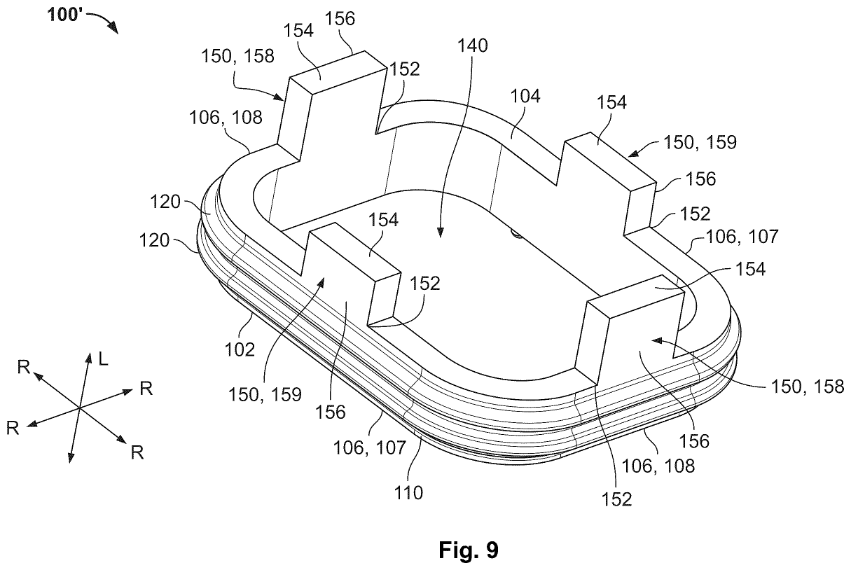

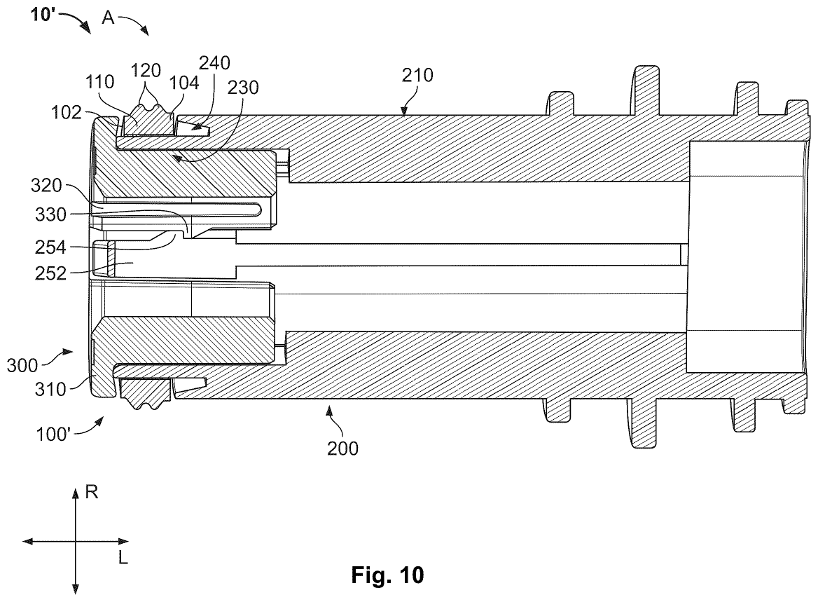

A seal 100′ according to another embodiment is shown in FIG. 9. The seal 100′ is part of a connector 10′ according to another embodiment, shown in FIG. 10. Like reference numbers refer to like elements and primarily the differences from the seal 100 and the connector 10 shown in FIGS. 1-8 and described above will be described in detail below.

The seal 100′, as shown in FIG. 9, does not have the shroud 130 of the seal 100 of FIG. 2. The body 110 of the seal 100′ extends from the first end 102 to the second end 104 of the seal 100′ and defines the sealing passageway 140 extending along the longitudinal direction L. The lugs 150 of the seal 100′ protrude from the body 110, extending from the second end 104 of the seal 100′ along the longitudinal direction L. The lugs 150 are separated from one another around a perimeter of the body 110.

Each of the lugs 150 has the connecting end 152 connected to the body 110 and extends to the protruding end 154 as a free end opposite the connecting end 152. The lugs 150 in the embodiment of FIG. 9 each have a same thickness along the radial direction R that is equal to a thickness of the body 110 along the radial direction R. The lugs 150 each have a consistent cross-sectional shape, a rectangular cross-sectional shape in the shown embodiment, between the connecting end 152 and the protruding end 154. The first set 158 of lugs 150 extend further from the body 110 along the longitudinal direction L than the second set 159 of lugs 150.

In the shown embodiment, the seal 100′, including the body 110, the sealing glands 120, and the lugs 150, is monolithically formed in a single piece. The seal 100′ may be formed from an elastomeric material, such as silicone, for example by molding.

The connector 10′ having the seal 100′ is shown in FIG. 10. In the embodiment of FIG. 10, the connector 10′ includes the same housing 200 as shown in FIG. 3 and the same cap 300 as shown in FIG. 5 and described in detail above; the cap 300 retains the seal 100′ on the housing 200 in the same manner as described above.

The seal 100′ is positioned on the housing 200, around the sealing portion 230, in the same manner as described with respect to the seal 100 above. Each of the lugs 150 of the seal 100′, as similarly shown in FIG. 1, is received in one of the locking slots 220; the lugs 150 of the first set 158 are each received in one of the first group 222 of locking slots 220 and the lugs 150 of the second set 159 are each received in one of the second group 226 of locking slots 220, with the protruding ends 154 of the lugs 150 adjacent to the end faces 221 of the locking slots 220. A section of the seal 100′ in the housing 200 taken along the first set 158 of the lugs 150 would be the same as for the seal 100 shown in FIG. 7.

The section of the connector 10′ shown in FIG. 10 is taken at the same location of the connector 10′ as the section of the connector 10 shown in FIG. 6. As shown in the connector 10′ of FIG. 10, at a section of the seal 100′ along a portion that does not have the lugs 150, the body 110 at the second end 104 of the seal 100′ abuts against the main portion 210 of the housing 200 along the longitudinal direction L. In the embodiment shown in FIG. 10, the seal 100′ does not have the shroud 130, so the seal channel 240 is not filled with a portion of the seal 100′.

In another embodiment of the connector 10′ having the seal 100′, instead of having the open space of the seal channel 240, the housing 200 can have a flat wall extending in the radial direction R from an end of the main portion 210 to the sealing portion 230. In this embodiment, the body 110 at the second end 104 of the seal 100′ abuts against the flat wall and is held in the same position shown in FIG. 10.

The connector 10, 10′ according to the embodiments described above can be repeatedly mated and unmated from the mating connector 30; each mating cycle imparts compressive and rotational forces on the seal 100, 100′. In the embodiments of the seal 100, 100′ described above, the lugs 150 prevent movement of the seal 100 during the mating cycle to ensure more reliable, long-term sealing to the connector 10, 10′. In the embodiment of the seal 100, the position of the shroud 130 in the seal channel 240 and the complementary tapered shapes of the shroud 130 and the seal channel 240 limit movement of the seal 100 in the longitudinal direction L and the radial direction R when the connector 10 is mated and unmated with the mating connector 30. In the seal 100, 100′, the engagement of the lugs 150 in the locking slots 200 limits rotation of the seal 100, 100′ about the longitudinal direction L. The seal 100, 100′ is also molded separately from the housing 200, which decreases the manufacturing cost of the seal 100, 100′ and allows the seal 100, 100′ to be removed and serviced or replaced if necessary.

1. A seal, comprising:
a body defining a sealing passageway extending along a longitudinal direction through the seal; and
a plurality of lugs separated from one another around a perimeter of the body and extending from the body along the longitudinal direction, the body and the lugs are monolithically formed in a single piece from an elastomeric material.

2. The seal of claim 1, wherein one of the lugs is positioned on each of a plurality of sides of the seal.

3. The seal of claim 1, further comprising a plurality of sealing glands extending from the body of the seal and spaced apart from one another along the longitudinal direction.

4. The seal of claim 1, wherein at least one of the lugs extends further from the body along the longitudinal direction than another one of the lugs.

5. The seal of claim 1, wherein the lugs each have a connecting end connected to the body and a protruding end as a free end opposite the connecting end along the longitudinal direction.

6. The seal of claim 5, wherein the lugs each have a same thickness along a radial direction perpendicular to the longitudinal direction.

7. The seal of claim 5, wherein the lugs each have a consistent cross-sectional shape between the connecting end and the protruding end.

8. The seal of claim 1, further comprising a shroud extending from the body to an end of the seal, the shroud defines the sealing passageway with the body, the lugs protrude from the shroud.

9. The seal of claim 8, wherein the shroud tapers from the body to the end along the longitudinal direction, an inner surface of the shroud extends along the longitudinal direction and an outer surface of the shroud is sloped and extends at an angle with respect to the longitudinal direction, the lugs protrude from the outer surface of the shroud.

10. The seal of claim 9, wherein each of the lugs extends from a connecting end to a protruding end along the longitudinal direction, the protruding end of each of the lugs protrudes further from the shroud than the connecting end in a radial direction perpendicular to the longitudinal direction.

11. A connector, comprising:
a housing; and
a seal disposed on the housing, the seal including a body defining a sealing passageway extending along a longitudinal direction through the seal and a plurality of lugs separated from one another around a perimeter of the body and extending from the body along the longitudinal direction, the body and the lugs are monolithically formed in a single piece from an elastomeric material, the housing is positioned in the sealing passageway.

12. The connector of claim 11, wherein the housing has a main portion and a sealing portion extending from the main portion along the longitudinal direction, the seal is disposed around the sealing portion.

13. The connector of claim 12, wherein the main portion has a plurality of locking slots extending into the main portion along the longitudinal direction and spaced apart from one another along a perimeter of the main portion.

14. The connector of claim 13, wherein each of the lugs is received in one of the locking slots.

15. The connector of claim 14, wherein an outer surface of each of the lugs is flush with or positioned within an outer surface of the main portion in an assembled state of the seal on the housing.

16. The connector of claim 15, wherein the seal has a shroud extending from the body to an end of the seal, the shroud defines the sealing passageway with the body, the lugs protrude from the shroud.

17. The connector of claim 16, wherein the housing has a seal channel between the main portion and the sealing portion, the shroud is positioned in the seal channel, the seal channel has a tapered shape complementary to the shroud.

18. A connector assembly, comprising:
a connector including a housing and a seal disposed on the housing, the seal including a body defining a sealing passageway extending along a longitudinal direction through the seal and a plurality of lugs separated from one another around a perimeter of the body and extending from the body along the longitudinal direction, the body and the lugs are monolithically formed in a single piece from an elastomeric material, the housing is positioned in the sealing passageway; and
a mating connector matable with the connector along the longitudinal direction, the seal is compressed between the housing of the connector and a mating connector housing of the mating connector.

19. The connector assembly of claim 18, wherein the housing has a main portion and a sealing portion extending from the main portion along the longitudinal direction, the seal is disposed around the sealing portion.

20. The connector assembly of claim 19, wherein the main portion has a plurality of locking slots extending into the main portion along the longitudinal direction and spaced apart from one another along a perimeter of the main portion, each of the lugs is received in one of the locking slots.
